(19) United States
(12) Patent Application Publication
(10) Pub. No.: US 2020/0317315 A1
(43) Pub. Date: Oct. 8, 2020

(54) VARIABLE HIGH ASPECT ROWING OAR

(71) Applicant: TRUEARC LLC, ASHBURN, VA (US)

(72) Inventor: J.D. MITCHELL, ALEXANDRIA, VA (US)

(21) Appl. No.: 16/375,541

(22) Filed: Apr. 4, 2019

(51) Int. Cl. B63H 16/04; F16B 9/00

(52) U.S. Cl. CPC B63H 16/04; F16B 9/02; F16B 9/058

(57) ABSTRACT

The invention relates to an offset joint for an oar to provide an offset angled and/or articulable blade, where the offset joint is an adjustable locking joint mounted on the outboard shaft end of the oar shaft, having a variable offset angle from 1-35 degrees to a cylindrical axis of the elongated shaft.

### CROSS REFERENCE TO RELATED APPLICATIONS

None

### STATEMENT REGARDING FEDERALLY SPONSORED RESEARCH OR DEVELOPMENT

None

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention relates to a competitive rowing oar, more particularly, but not exclusively, an oar that features a pivot or a fixed angle near the blade that allows the blade to be pivoted or angled to increase the angle of attack the oar enters and exits the water.

### Background

In rowing, oars are used to propel the boat. Oars differ from paddles in that they use a fixed fulcrum, an oarlock attached to the side of the boat, to transfer power from the handle to the blade.

Rowing is a competitive sport first introduced at the first Olympic Games in 1896. Women's Rowing was introduced with in the 1976 Olympic Games.

Significant improvements have been made over the construction of the boats and the riggers attached to the boat. Carbon fiber is now while used to produce hulls that are light, easily maintained and stiff. Hull shapes have improved. Oar have also undergone improvements, with the use of lighter materials, improved shaft design and shape, and improved design of the blade itself.

When the rower uses one oar on one side, it is called sweep rowing that the single oar is called a “sweep” oar. When the rower uses two oars at the same time, one on each side, it is called sculling, and the two oars are called a pair of “sculls”. Typical sculls are approximately 284 cm-290 cm in length; and sweep oars are 370 cm-376 cm. A scull has a smaller blade area, as each rower wields a pair of them at any one time, operating each with one hand.

Since the 1980s most oars have been adjustable in length. The shaft of the oar ends with a thin flat surface 40 to 50 cm long and 25 cm wide, variously called the blade or spoon. Further along are the loom (or shaft), ⅔ of the way up which is the Sleeve (including a wear plate) and Button (or collar), and at the very end the Handle.

The Handle may revert to wooden or, particularly in the case of sculls and some 21st century models of sweep-oar blades have rubber, cellular foam, suede or for example wood veneer grips over glass fiber.

The Sleeve features a “neutral” pitch, that is when the blade in a vertical position the sleeve is also at the identical vertical pitch. The Sleeve interacts with the oarlock to impart a pitch of four degrees. That is the upper edge of the blade leads the lower edge by 4 degrees. This pitch allows the oar to travel through the water without jumping up and down and without the blade diving down with a violent downward motion.

The part of the oar the rower holds while rowing is the handle. The handle is longer for sweep blades as each is held using both hands, than it is for sculls which are held with one hand.

There are hundreds of different variations of oars in terms of size and manufacturer specifications. “Macon” or “Cleaver” blade shapes of carbon-fibre are the most common in modern-day rowing. Classic oars were made out of wood. Since the use of such synthetic materials, first mass-produced by Dreissigacker in 1975, the weight of an oar has come down from over 7 kg to less than 2.5 kg and 1.275-1.8 kg in the case of sculls.

While rowing in the most common competitive boats, fine boats (racing shells), oars are since the early part of the 20th century supported by metal or fiberglass/carbon fiber frames attached to the side of the boat called riggers for extra leverage. The most common shape now seen is the “cleaver” (also called “hatchet”), which is used almost universally. Cleaver blades are asymmetrical, with a somewhat rectangular shape resembling a meat cleaver, hence the name.

The shaft of a cleaver blade connects to the blade offset to the top corner of the blade. The shape of the face and the offset connection is designed to maximize the surface area of the blade in contact with the water during the rowing stroke, while also minimizing the amount and depth of the shaft that is submerged and contributing to drag. As the cleaver blade is asymmetrical it may only be used on one side of the boat or the other.

Cleaver blade designs were first developed by Dick and Pete Dreissigacker in 1991. They are now manufactured by most major rowing oar suppliers, including Concept 2 (Dreissigacker) and Croker (an Australian Company). Concept 2 oars are used by approximately 66% of rowers and 29% use Croker.

Much research has been performed on the improvement of the efficiency of the blade through the water. Most of the research has been focused on the shape of the blade, and the hydrodynamic features. In all cases however the relationship of the blade to the shaft and sleeve has remained constant. That is the vertical surface of the blade is inline with the Sleeve.

In a modern system, the sleeve is placed into the oarlock, that acts as a lever and when pulled at the Handle the boat is propelled forward. The Blade moves in an arc around the oarlock.

At the beginning of the Stroke, known as the Catch, the blade will normally be 55 degrees in sweep, and as much as 70 degrees in sculling. The Oar is pulled and is terminated at an angle of 35 degrees. In sweep the Blade travels an Arc of 90 degrees.

Conventional understanding of the rowing stroke postulates the force against the oarlock, by the oar, increases from the catch and peaks at the mid-drive (oar is 90 degrees to the boat) and then decreases as the hands are pulled into the body.

Some practitioners note that the Blade at 90 degrees, in relationships to the center of the boat, is the most efficient and therefore have devised oars that maintain the blade at a perpendicular to the center line of the boat. U.S. Pat. No. 7,144,284.

Such beliefs are misguided. At the Catch the boat is moving the slowest. In a conventional system, the blade would enter the water at 55 degrees. Acceleration studies indicate that the boat continues to slow for a certain short period of time after the catch. Effectively putting a blade perpendicular to the boat would create a large braking force.

Other practitioners have opined that the Blade acts as a wing through the water and creates Lift and Drag. With the largest Lift at the Catch and the least at 90 degrees. After 90 degrees the oar is thought to act only as a drag device. Acceleration studies indicate that after the oar passes 90 degrees, the boat is in a deceleration mode.

Many elite rowers are taller individuals and are able to have significantly larger catch angles. A larger catch angle propels the boat faster. The oar, whether due to the Lift and Drag characteristics, or the Oar acting as a true lever, the greater force is imparted at a greater catch angle. The faster the blade enters the water the more quickly the lift provided by the blade can develop. Successful elite rowers frequently use extremely large catch angles, perhaps using the lift force of the blade to generate lift and speed.

There remains, a very real and substantial need for an effective means for improving the function of the oar.

### SUMMARY

The instant invention provides a mean to increase the catch angle of the oar. All current oars have the alignment of the Blade with the Sleeve in the same plane. In the instant invention, the Blade and the Shaft are joined by a variable joint that allows the Blade to be moved to an offset angle creating a higher angle of the blade. That is the Blade moves to the Bow side of the boat, from one degree to as much as 35 degrees. The joint is comprised of two circular disks that mate together. The disks are imprinted with teeth with varying degree intervals. The upper disk is connected to a tube that connects to the shaft of the oar and the lower disk is connected to the blade by a small shaft. The two disk mate together at an angle defined by the user. Once the new angle of attack is selected the two mating surfaces are held together by a conventional bolt and nut. A cover over the assembly provides a hydrodynamic flow should the joint be immersed in water.

In new oars, manufactured with the joint in place, the tube to blade is glued to the interior of the blade shaft. As such the shape of the connecting shaft is determined by the oar manufacturer seeking to use the present invention. The connecting tubes may either be connected internally to the oar shaft and the blade, or may be connected to the exterior of the shaft.

In oars that are to be retro fitted, with the joint, the existing oar is cut approximately 5-10 cm from the point where the blade and the shaft are connected. The joint is place between the two resulting parts and glued in place. Alignment markers on the joint provide guidance to the user, so that when joined the two parts stay in alignment. Once in place the user is able to select his catch angle.

In another embodiment of this invention, the user may select a fixed angle, and the oars built with a fixed angle of attack.

In another non-limiting preferred embodiment of the invention, there is provided herein an oar with an articulable blade, comprising: (i) an elongated shaft, the elongated shaft having an inboard shaft end and an outboard shaft end, a handle attached to the inboard shaft end, a sleeve mounted on the elongated shaft between the inboard shaft end and the outboard shaft end, a collar mounted on the sleeve, (ii) an adjustable locking joint mounted on the outboard shaft end of the elongated shaft, the adjustable locking joint having a variable offset angle from 1-35 degrees to a cylindrical axis of the elongated shaft, and (iii) a blade mounted on the adjustable locking joint.

In another non-limiting preferred embodiment of the invention, the oar includes wherein the adjustable locking joint is comprised of a fastener member, a first joint half and a second joint half, each of said joint halves having a tubular end cap with an inner diameter configured to fit an outer diameter of the elongated shaft, and each of the joint halves having an adjustable locking connecting member, wherein tightening the fastener member lockably connects the joint halves together and loosening the fastener member separates the joint halves to allow the joint halves to rotate about a shared axis and change the variable offset angle of the cylindrical axis of the elongated shaft to the blade.

In another non-limiting preferred embodiment of the invention, the oar includes wherein the fastener member is selected from a threaded bolt and nut, a self-locking friction pin and collar, a wire locking pin, and a clevis (stud) pin with ring or cotter pin fastener.

In another non-limiting preferred embodiment of the invention, the oar includes wherein the adjustable locking connecting member of each of the joint halves comprises a mating surface having alignable tooth projections.

In another non-limiting preferred embodiment of the invention, the oar includes wherein the mating surface is a planar ring having a central axis perpendicular to a cylindrical axis of the shaft.

In another non-limiting preferred embodiment of the invention, the oar includes wherein the alignable tooth projections of the mating surface are around the entire circumference of the mating surface.

In another non-limiting preferred embodiment of the invention, the oar includes wherein the alignable tooth projections of the mating surface are mounted at intervals ranging from 1-5 degrees.

In another non-limiting preferred embodiment of the invention, the oar includes wherein the alignable tooth projections of the mating surface are positioned in partial segments of the circumference of the mating surface.

In another non-limiting preferred embodiment of the invention, the oar includes wherein the joint halves each have a planar ring-shaped mating surface having alignable tooth projections, said projections selected from square profile tooth projections, involute tooth projections, and serrated tooth projections.

In another non-limiting preferred embodiment of the invention, there is provided a method of adjusting the offset angle of an oar blade, comprising the steps of: (1) providing an oar as claimed and described herein; (2) loosening the fastener member separates the joint halves to allow the joint halves to rotate about a shared axis and change the variable offset angle of the cylindrical axis of the elongated shaft to the blade; (3) changing the variable offset angle from a first angle to a second angle different from the first; and, (4) tightening the fastener member to lockably connect the joint halves together.

### BRIEF DESCRIPTION OF THE DRAWINGS

FIG. 1 shows an “aerial” view of a boat with the rigger attached and an oar through an oarlock and a conventional oar overlaying the path of the oar

FIG. 2 shows a side view of a typical prior art oar and the preferred embodiment illustrated.

FIG. 3 shows an exploded view of the joint.

FIG. 4 shows a detailed view of the joint.

FIG. 5 shows a side view illustration of the joint showing the opening for the either the shaft of the blade attachment Point.

FIG. 6 shows a side view of the preferred embodiment illustrated.

FIG. 7 shows a schematic “aerial” view of the path of the oar, moving at a constant speed, showing the movement of the of the boat past the boat and the impact of the preferred embodiment on the catch angle illustrated.

FIG. 8 is an illustration of a sweep embodiment showing a rower in a boat with an enhanced sweep angle joint mounted on the elongated oar shaft.

FIG. 9 is an illustration of a scull embodiment showing a rower in a boat with an enhanced sweep angle joint mounted on each of the elongated oar shafts.

FIG. 10 is an illustration of a sleeve and a collar.

FIG. 11 is an illustration of a locking gear.

FIG. 12 is an illustration of a joint half having a mating surface with a partial segment of toothed projections placed 5 degrees apart providing from 0-35 degrees of offset.

FIG. 13 is an illustration of a serrated tooth projection locking hinge.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Rather, these embodiments are provided so that this disclosure will be thorough and complete, and will fully convey the scope of the invention to those skilled in the art. Like numbers refer to like elements throughout. As used herein the term “and/or” includes any and all combinations of one or more of the associated listed items.

The terminology used herein is for the purpose of describing particular embodiments only and is not intended to limit the full scope of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following terms, as used herein, have the following meanings.

“Rigger” means the structural frame attached to the gunwale (gunnel, or side) of a boat that is used for mounting the oarlock.

“Boat” or “rowing shell” refers to sweep boats, sculling boats, canoes, and any other rowing boats for which it would be convenient to provide a central axis oarlock or provide constant gearing throughout the arc of an oar in a boat.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Detailed Description of the Figures

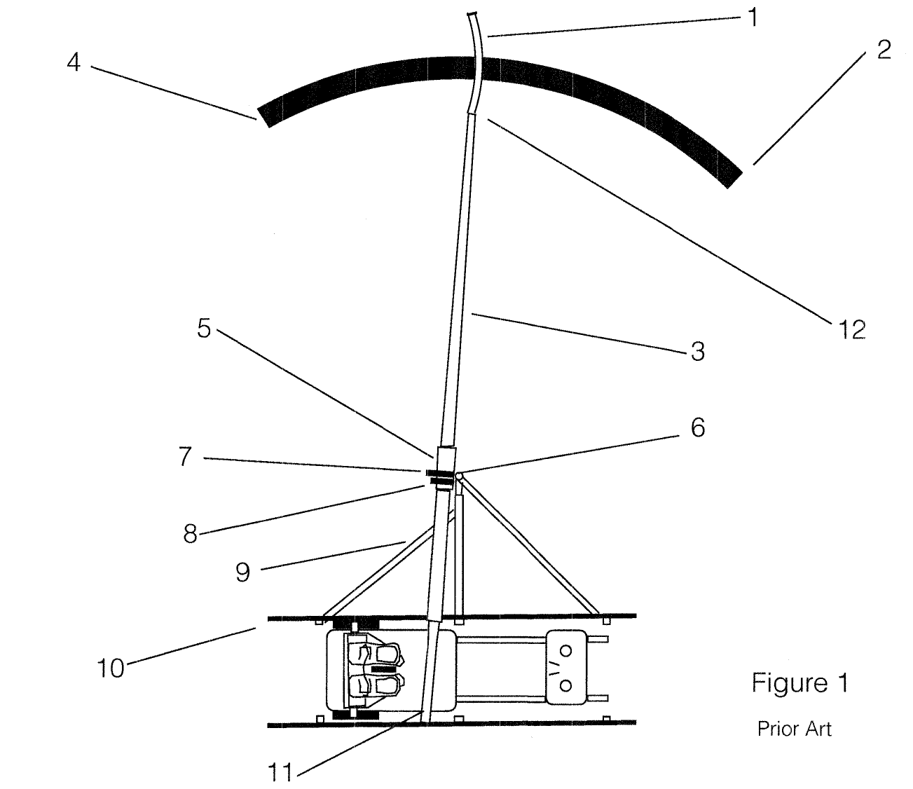

Referring to the drawings, FIG. 1 shows an aerial view of a shell, oarlock pin, rigger and oar assembly. Oarlock 7 which is rotatable secured to an oarlock pin 6 and is fixedly secured to the gunwale of a boat of a rowing shell by suitable struts or rigger 6. An oar 3 with a surface 1, known as a “blade” is received into the oarlock surround by collar 8. The oar 3 moves rotational in the oarlock 7. Pressure is exerted against surface 1 and transmitted to the oarlock pin at point 6 by pulling on handle 11. The Oar 3 is moved an arc to a catch point 2, placed into the water and pulled along the course of the arc to the finish point 4. The pressure against surface 1 propels the boat L0 forward. The effectiveness of the Oar 3 is determined by the angle between point 6 and catch angle 2. The greater the catch angle, the more force that can be exerted onto Blade 1. The catch angle is limited by the ability of a rower to move the Handle 11.

FIG. 1 is a typical representation of all the basic components used at the Olympics, World Championships, College, and High School Regattas.

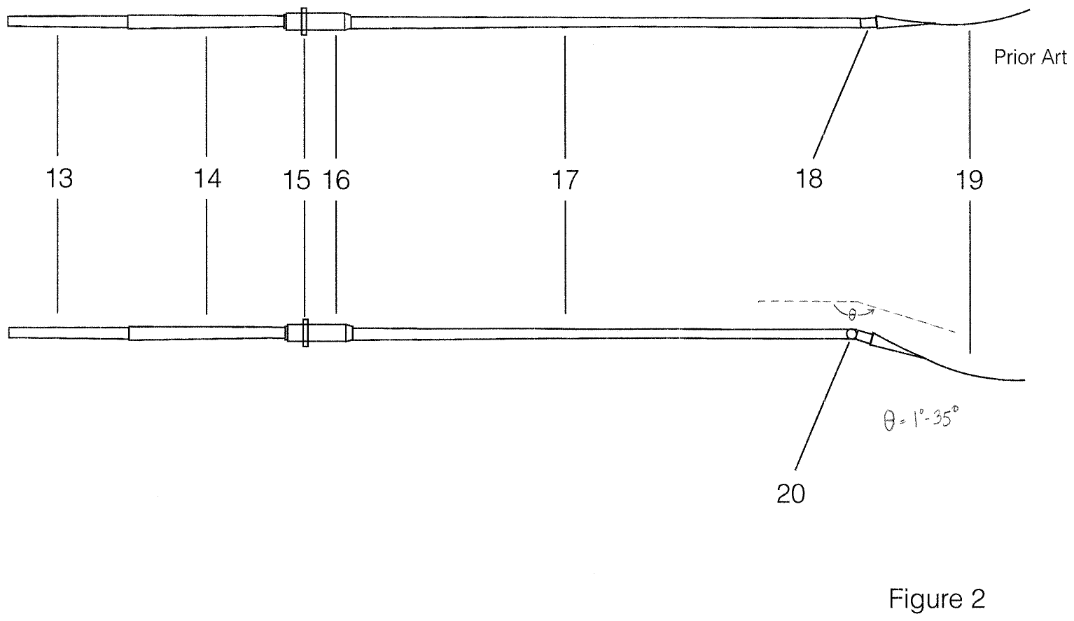

FIG. 2 is a side view of an Oar with the components Handle 13, Inboard Shaft 14, the Button or Collar 15, the Sleeve 16, the Outboard Shaft 17, the Blade 19 and the point of connection between Blade and Shaft 18. In the Prior Art the Blade 19 is firmly attached to the Outer Shaft at Point 18. The Blade is affixed in line with the Shaft such that as the Blade is pulled through the water it is perpendicular or nearly perpendicular to the surface of the water.

In the preferred embodiment at Point 20, the blade is attached to the Outboard Shaft 17, with a joint 20, that allows the Blade 19 to change the angle of attack in relationship to the OutBoard Shaft 17.

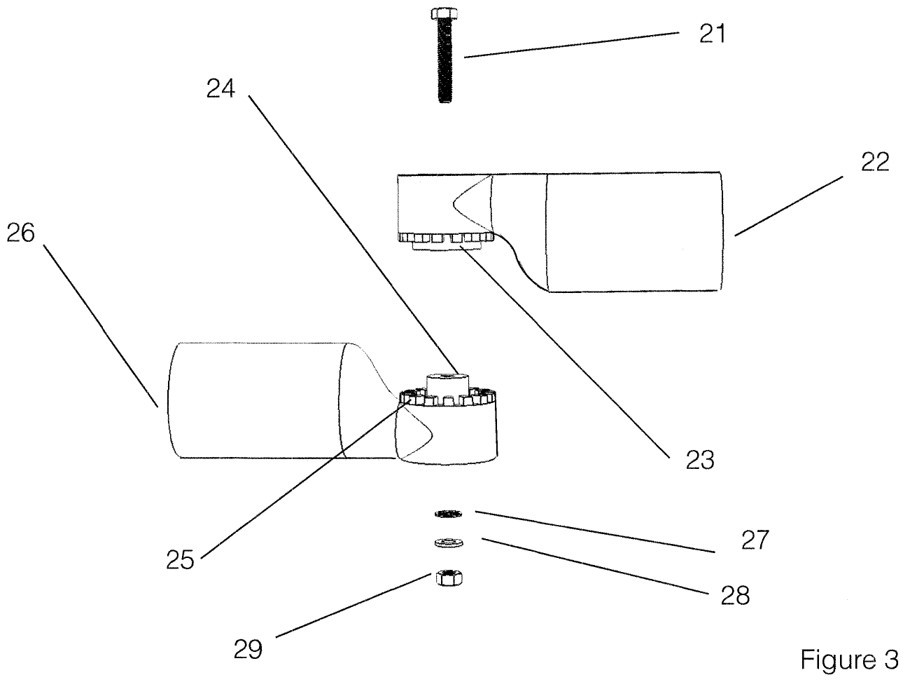

FIG. 3 is an “exploded” view of the preferred embodiment. The Blade Assembly is affixed at Point 22 and the OutBoard Shaft is affixed at Point 26. In this example, the Blade and The OutBoard Shaft are inserted into the Preferred Embodiment as the Male in a Male-Female Configuration. Alternatively the Preferred Embodiment may be constructed such that it is the Male and the Outboard Shaft and Blade is the female. The angular relationship is determined by the placing the teeth 23 with the teeth 25. Surface 24 mates to a corresponding surface interior to teeth 23. The entire assembly is secured with a bolt 21, a washer 27, a locking washer 28 and a nut 9.

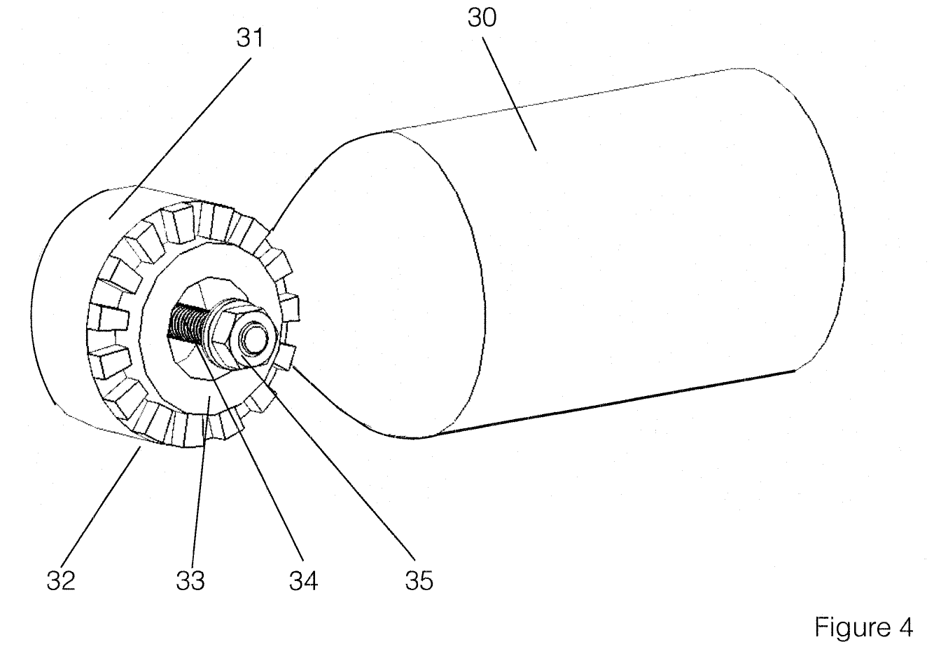

FIG. 4 shows a detailed view of one portion of the Preferred Embodiment. The Body 30 is attached to the Head 31 with teeth 32 surrounding a mating surface 33 and a nut washer, nut assembly 35.

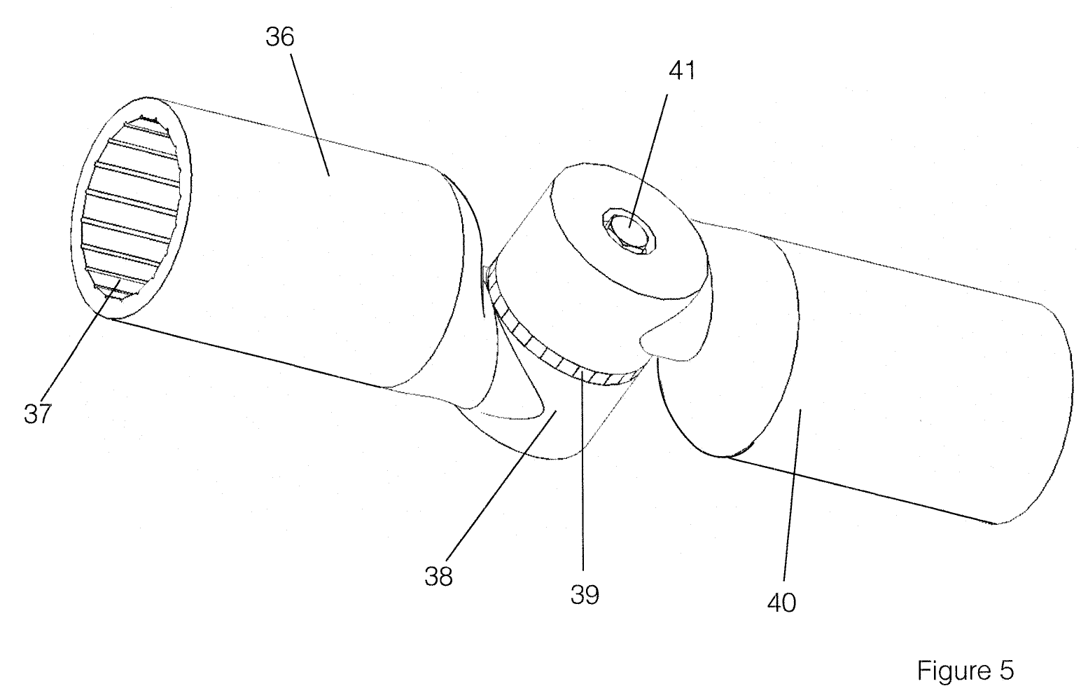

FIG. 5 shows a perspective view the Preferred Embodiment with Surface 37 designed to allow for attachment of the Outboard Shaft with adhesives. The assemblies are mated together with teeth 39 and secured with nut and bolt assembly 41. In FIG. 5 the Preferred Embodiment is shown in a liner configuration, however the relationship between bodies 36 and 40 is changeable by rotation around the Nut and Bolt Assembly 41.

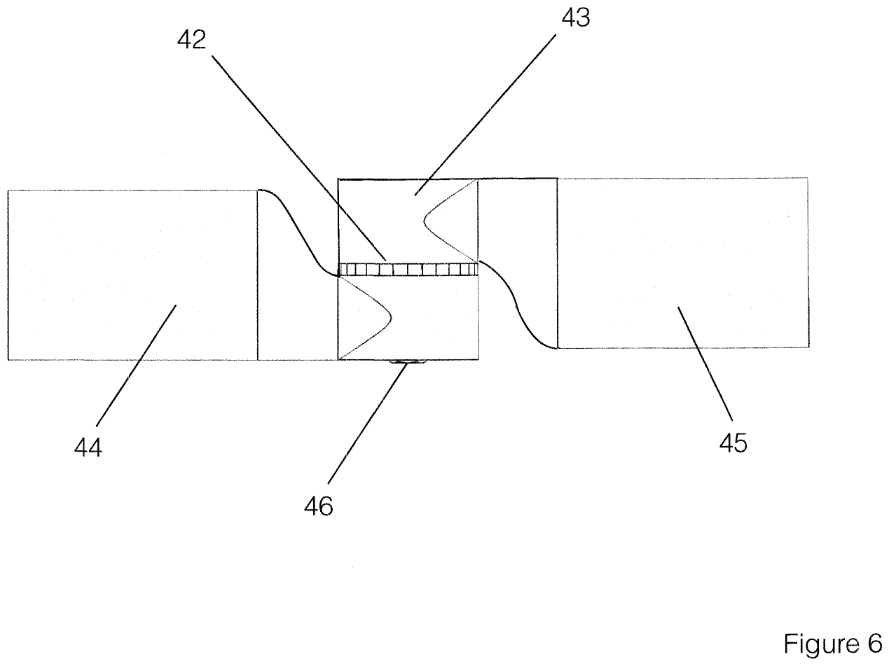

FIG. 6 shows a side view of the preferred embodiment.

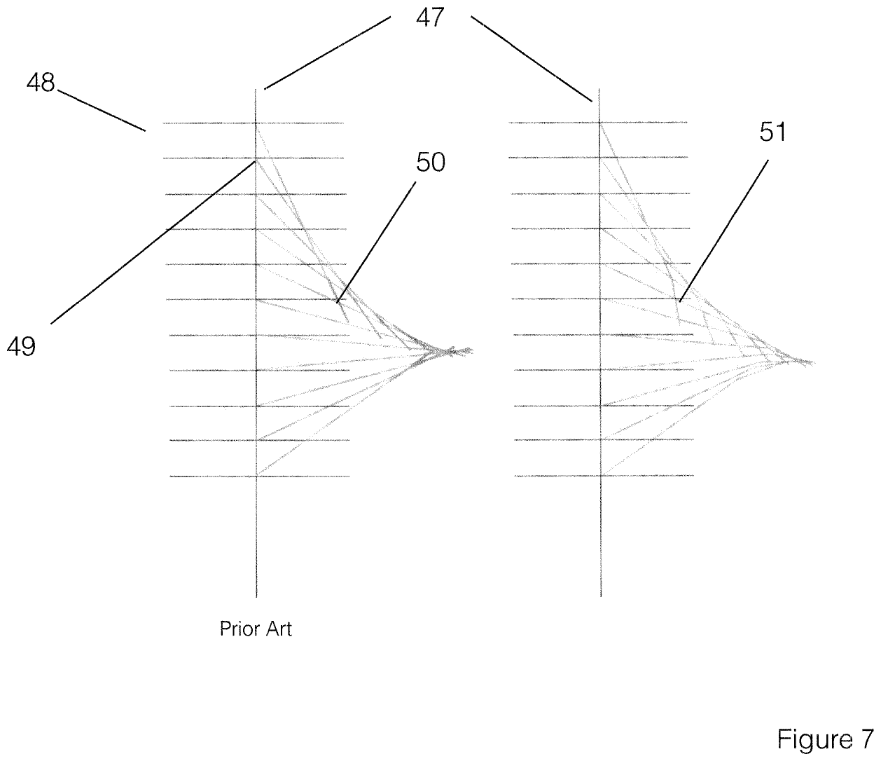

FIG. 7 schematically represents the movement of the blade. In the Prior Art the Blade 50 is shown at the Catch. The Oarlock of the boat 49 move along the path of the Boat 47, with the speed represented by the spacing on lines 48. In the Preferred Embodiment the oar angle 51 is increased. The increase in the catch angle 51 determines the speed of the boat. Conventional understanding is the catch angle does impact the force exerted on the oarlock pin but the impact is minimal. This understanding is incorrect. The most force is exerted at the Catch and increases as the Catch Angle is increased at Sine Angle. With this understanding the need to increase the catch angle is fundamental to achieving boat speed. But the angle cannot be increased due to the limitation of length of the rowers arms. Rowers are typically taller individuals that use height to increase catch angle. The preferred embodiment allows for the catch angle to be increased and to be set to an angle that could not be obtained in a normal configuration.

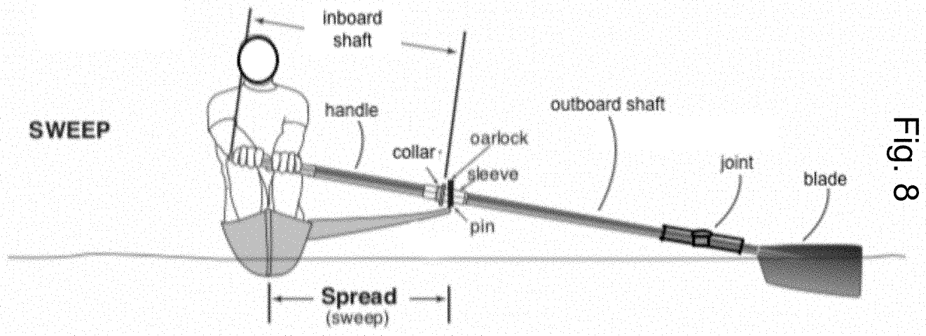

FIG. 8 is an illustration of a sweep embodiment showing a rower in a boat with an enhanced sweep angle joint mounted on the elongated oar shaft. FIG. 8 shows the arrangement of blade to joint to shaft.

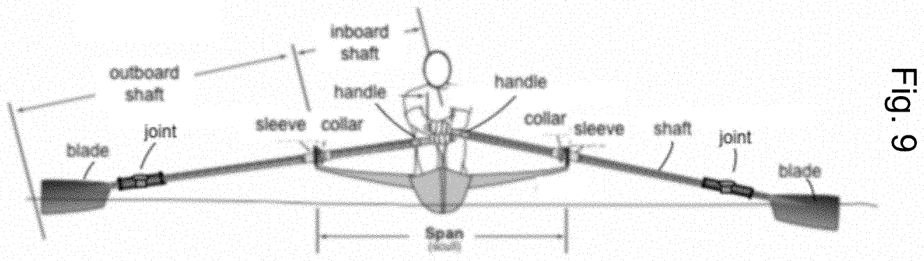

FIG. 9 is an illustration of a scull embodiment showing a rower in a boat with an enhanced sweep angle joint mounted on each of the elongated oar shafts. FIG. 9 shows the arrangement of blade to joint to shaft.

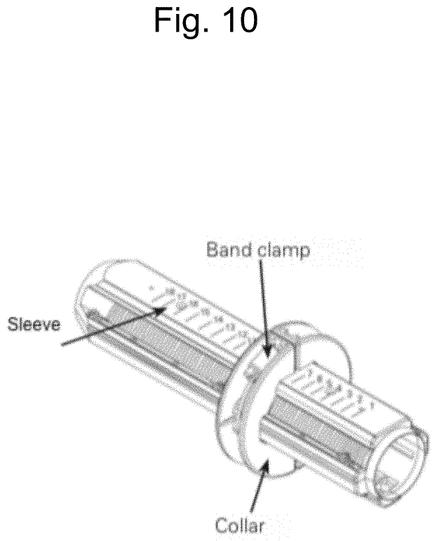

FIG. 10 is an illustration of a sleeve and a collar. FIG. 10 shows that the sleeve is a tube having a central lumen through which the shaft is mounted. Collar is similarly mounted on the outer surface of the sleeve.

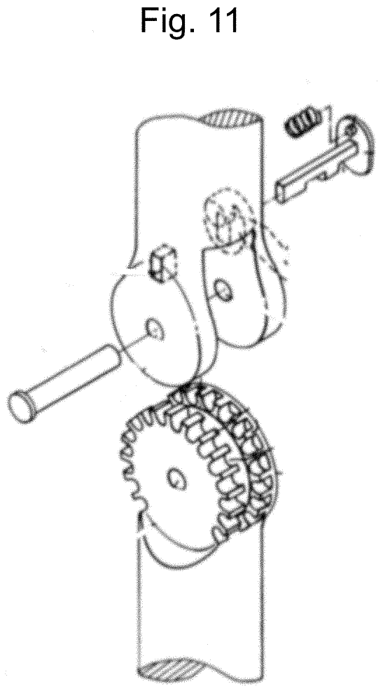

FIG. 11 is an illustration of a locking joint. FIG. 11 shows how shaft stubs can be connected using a variation of a rotatable, locking joint. In this variation, the locking teeth are only on one of the joint halves while the other joint half provides the axial pin that mounts one half joint onto the other, as well as locking key member that is inserted through the second joint half to lockably engage the teeth of the first joint half.

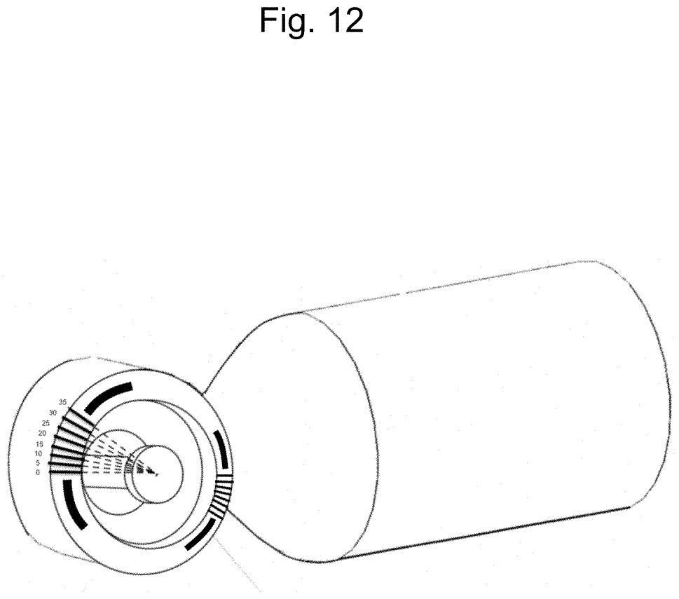

FIG. 12 is an illustration of a joint half having a mating surface with a partial segment of toothed projections placed 5 degrees apart providing from 0-35 degrees of offset. FIG. 12 shows a variation whereby locking projections are not necessary on the entire planar mating surface since the offset angle is limited to 35 degrees or less.

In a preferred embodiment, the invention provides as a non-limiting feature that the offset angle may be up to 60 degrees, range from 10-50 degrees, range from 10-40 degrees, range from 5-40 degrees, range from 5 to 35 degrees, range from 1-40 degrees, as well all included sub-ranges therein.

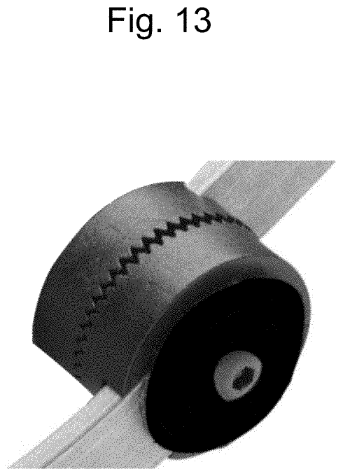

FIG. 13 is an illustration of a serrated tooth projection locking hinge.

### EXAMPLE

Provided herein is an oar with a joint that provides for an articulable (adjustable) blade. The oar comprises an elongated shaft, the elongated shaft having an inboard shaft end and an outboard shaft end, a handle attached to the inboard shaft end, a sleeve mounted on the elongated shaft between the inboard shaft end and the outboard shaft end, a collar mounted on the sleeve. The adjustable locking joint is mounted on the outboard shaft end of the elongated shaft, and has a variable offset angle from 1-35 degrees to a cylindrical axis of the elongated shaft. The blade is mounted on the distal, or far, side of the adjustable locking joint.

### Example

### Fibers

The shaft may be made of carbon fiber, wood, fiberglass, plastic, aluminum, and composite materials made from specialty fibers. Fibers contemplated herein include additional filaments being selected from the group consisting of: modified carbon fiber, modified polyacrylonitrile, polyacrylonitrile, rayon, nylon, aramid, olefins, carbon, glass, liquid crystal polymer filaments including melt spun fibers of a polycondensate of 4-hydroxybenzoic acid (HBA) and 6-hydroxynaphthalene-2-carboxylic acid (HNA) monomers (HBA/HNA), and polyethylene including ultra high molecular weight polyethylene (UHMWPE), and combinations thereof.

### Example

### Resins

In a preferred embodiment, the composite may be constructed using a combination of fiber reinforcement and a resin matrix. The resin system holds everything together, and transfers mechanical loads through the fibers to the rest of the structure. In addition to binding the composite structure together, it protects from impact, abrasion, corrosion, other environmental factors and rough handling. Resin systems come in a variety of chemical families, each designed and designated to serve industries providing certain advantages like economic, structural performance, resistance to various factors, legislation compliance, etc. Resins of the thermoset family are described below, and include polyester (orthophthalic and isophthalic), vinyl ester, epoxy, and phenolic.

### Example

### Composites

A composite is a solid material, made out of two or more constituent, different and distinct substances that retain their physical characteristics, while contributing desirable properties to the whole. Composite materials generally include three functions. A matrix function feature that surrounds, supports and maintains position of a reinforcement. A reinforcement function feature that provides one or more special physical characteristics, e.g. mechanical or electrical. And a core function feature used in-between the layers of fiber reinforced matrix forming a type of sandwich structure. When matrix and reinforcement are combined in a laminate to form a new material, this can result in a synergistic characteristic or feature.

Some of the benefits of composite materials include higher mechanical properties like strength and stiffness, lighter weight, higher performance, energy savings, durability, fatigue resistance and longer service life, impact resistance, dimensional stability, anisotropic properties, chemical properties, corrosion resistance, fire retardance, high temperature service, environment outdoor service, low maintenance requirements, low thermal conductivity, low or custom thermal expansion, tailored energy conductivity, (e.g. can be used to amplify or dump vibration), tailored electric properties (insulation or conduction capability), and so forth.

It is contemplated as within the scope of the invention to manufacture a jointed oar from resin and fiber composites, especially to provide properties of less weight, increased durability, reduced electrical conductivity (oar hits power line injuries), increased performance, and so forth.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

I claim:

1. An oar with an articulable blade, comprising:
an elongated shaft, the elongated shaft having an inboard shaft end and an outboard shaft end, a handle attached to the inboard shaft end, a sleeve mounted on the elongated shaft between the inboard shaft end and the outboard shaft end, a collar mounted on the sleeve,
an adjustable locking joint mounted on the outboard shaft end of the elongated shaft, the adjustable locking joint having a variable offset angle from 1-35 degrees to a cylindrical axis of the elongated shaft, and
a blade mounted on the adjustable locking joint.

2. The oar of claim 1, wherein the adjustable locking joint is comprised of a fastener member, a first joint half and a second joint half, each of said joint halves having a tubular end cap with an inner diameter configured to fit an outer diameter of the elongated shaft, and each of the joint halves having an adjustable locking connecting member, wherein tightening the fastener member lockably connects the joint halves together and loosening the fastener member separates the joint halves to allow the joint halves to rotate about a shared axis and change the variable offset angle of the cylindrical axis of the elongated shaft to the blade.

3. The oar of claim 2, wherein the fastener member is selected from a threaded bolt and nut, a self-locking friction pin and collar, a wire locking pin, and a clevis (stud) pin with ring or cotter pin fastener.

4. The oar of claim 2, wherein the adjustable locking connecting member of each of the joint halves comprises a mating surface having alignable tooth projections.

5. The oar of claim 4, wherein the mating surface is a planar ring having a central axis perpendicular to a cylindrical axis of the shaft.

6. The oar of claim 5, wherein the alignable tooth projections of the mating surface are around the entire circumference of the mating surface.

7. The oar of claim 5, wherein the alignable tooth projections of the mating surface are mounted at intervals ranging from 1-5 degrees.

8. The oar of claim 5, wherein the alignable tooth projections of the mating surface are positioned in partial segments of the circumference of the mating surface.

9. The oar of claim 2, wherein the joint halves each have a planar ring-shaped mating surface having alignable tooth projections, said projections selected from square profile tooth projections, involute tooth projections, and serrated tooth projections.

10. The oar of claim 1, wherein the blade is mounted on the adjustable locking joint using an internal tube connector having an exterior cylindrical diameter that matches the interior diameter of a blade mounting sleeve attached to the blade and matches the interior diameter of a joint mounting sleeve attached to the joint.

11. The oar of claim 1, wherein the joint is mounted on the outboard shaft end of of the elongated shaft using an internal tube connector having an exterior cylindrical diameter that matches the interior diameter of a joint mounting sleeve attached to the joint and matches the interior diameter of the outboard shaft end of of the elongated shaft.

12. A method of adjusting the offset angle of an oar blade, comprising the steps of:
providing an oar of claim 1;
loosening the fastener member separates the joint halves to allow the joint halves to rotate about a shared axis and change the variable offset angle of the cylindrical axis of the elongated shaft to the blade;
changing the variable offset angle from a first angle to a second angle different from the first; and,
tightening the fastener member to lockably connect the joint halves together.

13. The method of claim 10, wherein the oar is the oar of claim 6.

14. A retrofit kit for an adjustable locking joint for an oar, comprising:
(i) directions for cutting an existing oar approximately 5-10 cm from a point where a blade and a shaft are connected, and for inserting, aligning and gluing a proximal stub portion of the cut shaft into a proximal side tubular end cap for the joint and for inserting, aligning and gluing a distal stub portion of the cut shaft into a distal side tubular end cap for the joint; and
(ii) adjustable locking joint for an oar, comprising a fastener member, a first joint half and a second joint half, each of said joint halves having a tubular end cap with an inner diameter configured to fit an outer diameter of the elongated shaft, and each of the joint halves having an adjustable locking connecting member, wherein tightening the fastener member lockably connects the joint halves together and loosening the fastener member separates the joint halves to allow the joint halves to rotate about a shared axis and change the variable offset angle of the cylindrical axis of the elongated shaft to the blade,
wherein the fastener member is selected from a threaded bolt and nut, a self-locking friction pin and collar, a wire locking pin, and a clevis (stud) pin with ring or cotter pin fastener
wherein the adjustable locking connecting member of each of the joint halves comprises a mating surface having alignable tooth projections.

15. The oar of claim 14, wherein the mating surface is a planar ring having a central axis perpendicular to a cylindrical axis of the shaft.

16. The oar of claim 15, wherein the alignable tooth projections of the mating surface are around the entire circumference of the mating surface.

17. An fixed angle joint for an oar, comprising: (i) a fastener member, a first joint half and a second joint half, each of said joint halves having a tubular end cap with an inner diameter configured to fit an outer diameter of an elongated shaft, and each of the joint halves connected by a fastener member to provide a permanent variable offset angle of 1-35 degrees from a cylindrical axis of an elongated shaft to a horizontal axis of an oar blade.
